(19) United States
(12) Patent Application Publication
(10) Pub. No.: US 2015/0211454 A1
(43) Pub. Date: Jul. 30, 2015

(54) HIGH PRESSURE FUEL PUMP

(71) Applicant: DENSO CORPORATION, Kariya-city (KR)

(72) Inventors: Hayaki TANABE, Kariya-city (JP); Takafumi NAITOU, Kariya-city (JP)

(21) Appl. No.: 14/603,797

(22) Filed: Jan. 23, 2015

(30) Foreign Application Priority Data
Jan. 24, 2014 (JP) 2014-11536

(51) Int. Cl. F02M 37/06; F04B 53/00; F04B 17/05; F04B 53/14; F04B 9/04; F02M 37/04; F04B 53/16

(52) U.S. Cl. CPC F02M 37/06; F02M 37/043; F04B 53/006; F04B 53/16; F04B 53/14; F04B 9/042; F04B 17/05

(57) ABSTRACT

A high pressure fuel pump includes a plunger, which slidably reciprocates along a slide axis in an inside of a cylinder, a tappet body, which reciprocates integrally with the plunger, and a roller, which is held by the tappet body and is rotated by rotation of a camshaft. When the roller and the cam main body are viewed in a direction of an axis of the camshaft, a contact point, at which the roller and the cam main body contact with each other, is displaced from an intersection point, at which the slide axis of the plunger and a tangent line to a circle of a cross section of the roller at the contact point intersect with each other, in a counter-rotational direction of the cam main body, which is opposite from a rotational direction of the cam main body.

### CROSS REFERENCE TO RELATED APPLICATION

This application is based on and incorporates herein by reference Japanese Patent Application No. 2014-11536 filed on Jan. 24, 2014.

### TECHNICAL FIELD

The present disclosure relates to a high pressure fuel pump.

### BACKGROUND

A high pressure fuel pump, which supplies high pressure fuel to an internal combustion engine, such as a diesel engine, is known. The high pressure fuel pump includes a camshaft, a plunger and a pressurizing chamber. The camshaft is connected to and is rotated by a crankshaft of the internal combustion engine. When the camshaft is rotated, the plunger is slidably reciprocated in a cylinder, which is formed in a housing. The pressurizing chamber is formed in the cylinder and has a variable volume, which varies upon reciprocation of the plunger. Fuel is supplied to the pressurizing chamber and is pressurized through the reciprocation of the plunger. Then, when a pressure of the pressurized fuel reaches a predetermined pressure, a discharge valve is opened. Thus, the pressurized fuel is supplied to a common rail of the internal combustion engine. For instance, JP2013-155698A (corresponding to US2013/0195692A1) discloses such a high pressure fuel pump that includes a tappet body, which is placed at a distal end of the plunger, and a roller, which is held by the tappet body. In this high pressure fuel pump, cam lobes, which are arranged one after another at predetermined intervals along an outer peripheral surface of the camshaft, and cam valleys, each of which is formed between corresponding adjacent two of the cam lobes, are alternately arranged, and the camshaft and the roller are arranged to contact with each other. When the camshaft is rotated, the cam lobes and the cam valleys alternately contact the roller to reciprocate the tappet body in an axial direction of the plunger while rotating the roller. In this way, the plunger is slidably reciprocated, so that the fuel supplied to the pressurizing chamber is pressurized.

In the above-described high pressure fuel pump, the roller is held by the tappet body while a predetermined clearance is interposed between an outer circumferential surface of the roller and the tappet body to enable rotation of the roller about a center of a circle of the roller (i.e., a center of a circle of a cross section of the roller) upon receiving a drive force in a rotational direction of the camshaft. Lubricant oil, which is supplied to a gap between the camshaft and the housing, enters this clearance to form an oil film and thereby to enable smooth rotation of the roller. In the tappet body and the roller, which are constructed in the above-described manner, the roller receives the drive force in the rotational direction of the camshaft. Therefore, a force is generated in a perpendicular direction, which is perpendicular to a rotational axis of the roller, i.e., in a tangential direction, which is a perpendicular direction that is perpendicular to a contact line, along which the camshaft and the roller contact with each other. In this rolling contact state where the roller receives the rotational force, which is exerted in the rotational direction about the center of the roller, due to wearing of the roller and/or the camshaft, the roller may contact the camshaft such that the camshaft locally contacts a front side portion of the roller, which is located on a front side along the contact line, or a back side portion of the roller, which is located on a back side along the contact line. Due to the localized contact discussed above, one of the rotational force of the roller at the front side portion of the roller and the rotational force of the roller at the back side portion of the roller may be increased, so that the roller may be turned about a slide axis of the tappet body, along which the tappet body slides. That is, the rotation of the roller about the rotational axis of the roller is limited, and there is generated a phenomenon of turning the roller (a phenomenon of turning the rotational axis of the roller) about the slide axis of the tappet body. This phenomenon is also referred to as a turning phenomenon. Due to the turning of the roller, the contact state between the roller and the camshaft is changed from the rolling contact state to a sliding contact state, in which the roller does not rotate about the rotational axis thereof and is slid relative to the camshaft. Thereby, a relative speed is generated between a rotational speed of the roller and a rotational speed of the camshaft, so that seizing of the roller may possibly occur through contact between the roller and the tappet body. The seizing of the roller limits the rotation of the roller about the rotational axis of the roller, so that the reciprocation of the plunger is interfered. As a result, the function of the high pressure fuel pump for pressurizing the fuel and supplying the pressurized fuel to the common rail may possibly be interfered.

### SUMMARY

The present disclosure is made in view of the above disadvantages.

According to the present disclosure, there is provided a high pressure fuel pump including a housing body, a cam main body, a plunger, a tappet body, and a roller. The housing body includes a cylinder, which is configured into a cylindrical form. The cam main body includes a plurality of cam lobes, which are radially outwardly projected. The cam main body is connected to a camshaft, which is rotated synchronously with a crankshaft of an internal combustion engine. The plunger slidably reciprocates along a slide axis in an inside of the cylinder of the housing body. The tappet body is placed on a side of the plunger, at which the cam main body is placed. The tappet body slidably reciprocates integrally with the plunger. The roller is held by the tappet body and is in contact with the cam main body. The roller is rotated by rotation of the camshaft and has a cross section that is configured into a circle. Fuel, which is drawn into a pressurizing chamber formed in the cylinder, is compressed and is discharged from the high pressure fuel pump when the plunger is reciprocated through the tappet body that is in turn reciprocated by the plurality of cam lobes, which are rotated by the rotation of the camshaft. The roller and the cam main body are arranged such that when the roller and the cam main body are viewed in a direction of an axis of the camshaft, a contact point, at which the roller and the cam main body contact with each other, is displaced from an intersection point, at which the slide axis of the plunger and a tangent line to the circle of the cross section of the roller at the contact point intersect with each other, in a counter-rotational direction of the cam main body, which is opposite from a rotational direction of the cam main body.

### BRIEF DESCRIPTION OF THE DRAWINGS

The drawings described herein are for illustration purposes only and are not intended to limit the scope of the present disclosure in any way.

FIG. 1 is a cross-sectional view of a high pressure fuel pump according to a first embodiment of the present disclosure;

FIG. 2 is an enlarged partial cross-sectional view of FIG. 1, showing a positional relationship between a roller and a cam main body, which contact with each other, according to the first embodiment;

FIGS. 3A and 3B are descriptive views for describing forces generated at the time of rotating the roller according to the first embodiment;

FIGS. 3C and 3D are descriptive views for describing a restoring force that limits turning of the roller according to the first embodiment;

FIG. 4 is a characteristic diagram showing a relationship between a tilt angle of a plunger and a discharge quantity of fuel at the high pressure fuel pump according to the first embodiment;

FIG. 5 is an enlarged partial cross-sectional view, showing a roller and a cam main body, which contact with each other, according to a second embodiment of the present disclosure;

FIG. 6 is an enlarged partial cross-sectional view, showing a positional relationship between a roller and a cam main body, which contact with each other, according to a third embodiment of the present disclosure; and

FIG. 7 is an enlarged partial cross-sectional view, showing a roller and a cam main body, which contact with each other, according to a fourth embodiment of the present disclosure.

### DETAILED DESCRIPTION

Embodiments of the present disclosure will be described with reference to the accompanying drawings. In the following description, similar components will be indicated by the same reference numerals throughout the embodiments and will not be described redundantly for the sake of simplicity. Furthermore, in the following embodiments, features of any two or more of the embodiments and modifications thereof may be combined together as long as there is no problem with respect to such a combination even if such a combination is not explicitly discussed in the present specification.

### First Embodiment

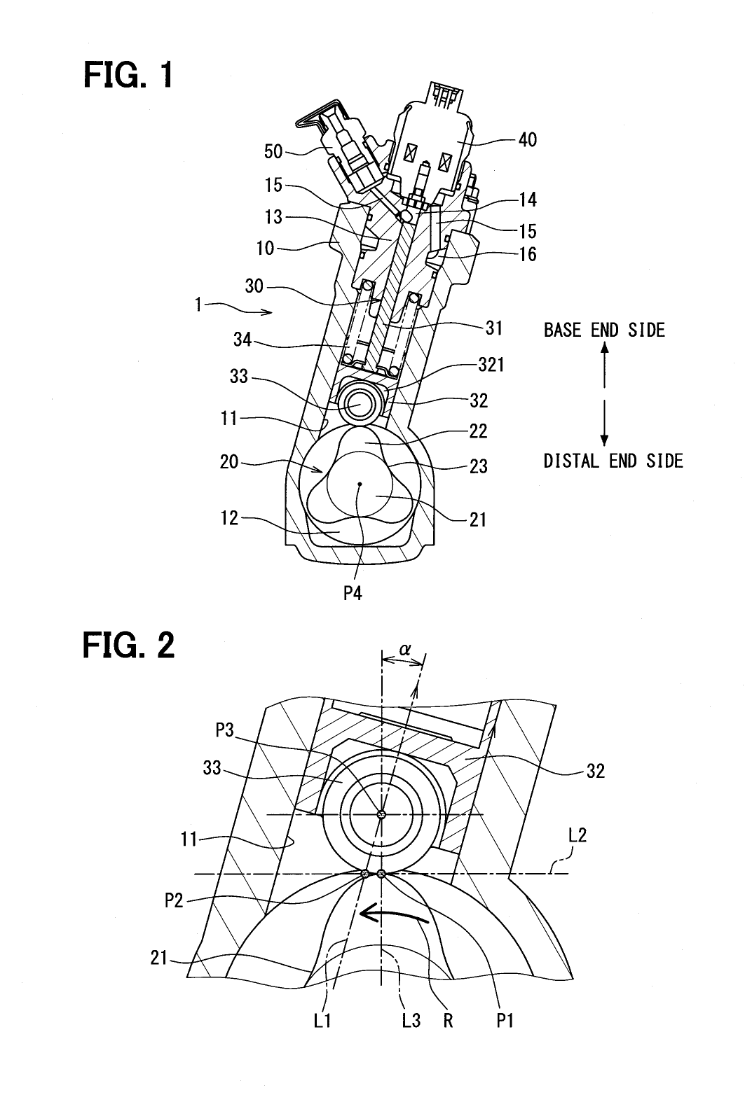

A high pressure fuel pump 1 according to a first embodiment of the present disclosure shown in FIGS. 1 and 2 is a high pressure fuel pump used in, for example, an internal combustion engine that combusts diesel fuel. The high pressure fuel pump 1 includes a housing body 10, a cam main body 21 and a slidable arrangement 30. The high pressure fuel pump 1 is connected to a fuel tank and a common rail (both not shown). The high pressure fuel pump 1 receives fuel from the fuel tank and supplies pressurized fuel to the common rail. In the present embodiment, a distal end side is a side of the housing body 10 where the cam main body 21 is placed, and a base end side is a side that is opposite from the distal end side.

The housing body 10 is configured into a cylindrical form and is made of an iron steel material, which has high rigidity to withstand a high pressure. The housing body 10 includes a cam chamber 12 and a cylinder 11. The cam chamber 12 is formed at the distal end side of the housing body 10 and is configured to have a circular cross section. The cam chamber 12 receives the cam main body 21. The cylinder 11 is configured into a cylindrical form and is communicated with the cam chamber 12 to receive the slidable arrangement 30. A base end body portion 13, in which a pressurizing chamber 14 and a fuel passage 15 are formed, is fixed to a base end side opening of the cylinder 11. A control valve 40 and a discharge valve 50 are installed to the base end body portion 13. The cylinder 11, which is formed in the inside of the housing body 10, is tilted relative to a camshaft 20, which is connected to the cam main body 21, in an opposite direction (hereinafter referred to as a counter- rotational direction of the cam main body 21), which is opposite from a rotational direction R of the cam main body 21 that is rotated about a center (a rotational center) P4 of the cam main body 21.

The slidable arrangement 30, which is installed in the inside of the cylinder 11, includes a plunger 31, a tappet body 32 and a roller 33. The plunger 31 is configured into a cylindrical form and is slidably received in a space that is formed to extend from the base end side toward the distal end side in the base end body portion 13. A portion of this space, in which the plunger 31 is not inserted, forms the pressurizing chamber 14, and fuel is supplied to this pressurizing chamber 14.

A tappet body 32 is provided to a distal end side of the plunger 31. Specifically, the tappet body 32 is placed on a side of the plunger 31, at which the cam main body 21 is placed. A distal end portion of the tappet body 32 is recessed to form a semi- cylindrical recess that serves as a holding portion 321 having a semi-cylindrical cross section. A roller 33 is held in the holding portion 321 such that a clearance is formed between an inner peripheral surface of the holding portion 321 and an outer circumferential surface of the roller 33. The roller 33 has a cross section that is configured into a circle (i.e., a circle formed by the outer circumferential surface of the roller 33).

As discussed above, the roller 33 is held by the tappet body 32 while the clearance (predetermined clearance) is interposed between the roller 33 and the tappet body 32. Specifically, the roller 33 is placed such that one half of the outer circumferential surface of the roller 33, which is located on a distal end side of a center P3 of the circle of the cross section of the roller 33 (hereinafter referred to as a center P3 of the circle of the roller 33) is partially covered by the tappet body 32. The center P3 of the circle of the roller 33 is a rotational center of the roller 33, about which the roller 33 is rotated. In other words, the center P3 of the circle of the roller 33 coincides with a rotational axis of the roller 33. With the above construction, although the clearance is provided between the roller 33 and the tappet body 32, the roller 33 is held by the tappet body 32 without falling out from the tappet body 32.

A spring (spiral spring) 34 is placed on a radially outer side of the plunger 31. A distal end part of the spring 34 is fixed to the tappet body 32, and a base end part of the spring 34 is fixed to the base end body portion 13. The spring 34 always urges the tappet body 32 toward the distal end side.

The cam main body 21, which is placed in the cam chamber 12 of the housing body 10, is connected to the camshaft 20, which is rotated synchronously with the crankshaft by the drive force of the internal combustion engine. Therefore, the cam main body 21 is synchronously rotated by the camshaft 20. A plurality of cam lobes 22 is arranged one after another at predetermined intervals along an outer peripheral surface of the cam main body 21, and the cam lobes 22 are radially outwardly projected. Furthermore, a cam valley 23 is formed between each circumferentially adjacent two of the cam lobes 22 such that the cam valley 23 is radially inwardly recessed from apexes of the adjacent cam lobes 22. When the cam main body 21 is rotated, the cam lobes 22 and the cam valleys 23 alternately slidably contact the roller 33. Thereby, the tappet body 32 and the plunger 31 slidably reciprocate in the axial direction of the cylinder 11 through the roller 33. In the present embodiment, the number of the cam lobes 22, which are formed in the cam main body 21, is three (3). Therefore, in the present embodiment, when the camshaft 20 makes one complete rotation (the rotation of 360 degrees), the plunger 31 is reciprocated three times. Thus, the high pressure fuel pump 1 is formed as a high pressure fuel pump that executes three pumping processes per rotation of the camshaft 20.

Lubricant oil flows from the outside into the cam chamber 12 of the housing body 10. The lubricant oil, which is supplied into the cam chamber 12, flows into a gap between the tappet body 32 and the cylinder 11, so that the tappet body 32 can smoothly slide in the cylinder 11. Furthermore, the lubricant oil enters into the clearance between the roller 33 and the tappet body 32 to form an oil film between the roller 33 and the tappet body 32, so that the roller 33 can be smoothly rotated. In addition, an oil film is also formed by the lubricant oil between the roller 33 and the cam main body 21 to limit, for example, occurrence of abnormal wearing between the roller 33 and the cam main body 21.

The control valve 40 is a known fuel metering valve, which includes a solenoid and an armature. The solenoid generates a magnetic attractive force upon energization thereof. The armature is magnetically attracted by the magnetic attractive force generated by the solenoid. The control valve 40 is placed in the fuel passage 15 of the base end body portion 13. When the control valve 40 receives a signal from an external ECU (not shown), the control valve 40 energizes the solenoid to magnetically attract the armature. In this way, control valve 40 opens the fuel passage 15. The fuel is supplied from the fuel tank to a low pressure fuel inlet 16. Then, the fuel, which is supplied to the low pressure fuel inlet 16, flows into the inside of the high pressure fuel pump 1. The fuel, which enters the inside of the high pressure fuel pump 1, is fed to the pressurizing chamber 14 through the fuel passage 15. At this time, the control valve 40, which is provided in the fuel passage 15, adjusts the quantity of the fuel supplied to the pressurizing chamber 14 by opening or closing the control valve 40. Furthermore, the fuel, which is pressurized through the reciprocation of the plunger 31, is supplied to the common rail through the discharge valve 50, which is provided in the base end body portion 13. The discharge valve 50 is a known valve that is provided in the fuel passage 15, which is communicated with the pressurizing chamber 14 and conducts the pressurized fuel. When the pressure of the fuel in the pressurizing chamber 14 reaches a predetermined pressure, the discharge valve 50 is opened. Specifically, the fuel in the pressurizing chamber 14 is compressed through the reciprocation of the plunger 31. When the pressure of the fuel in the pressurizing chamber 14 reaches the predetermined pressure, the discharge valve 50 is opened, and thereby the fuel is fed to the common rail.

As discussed above, in the high pressure fuel pump 1, the fuel is supplied from the low pressure fuel inlet 16 to the control valve 40 through the fuel passage 15, and the control valve 40 meters the fuel, i.e., adjusts the quantity of the fuel conducted through the fuel passage 15. Then, the fuel is supplied to the pressurizing chamber 14 through the control valve 40. Thereafter, the fuel, which is supplied into the pressurizing chamber 14, is compressed by the plunger 31, which is driven upward through the rotation of the cam main body 21, and the compressed fuel is discharged from the high pressure fuel pump 1 through the discharge valve 50.

Next, with reference to FIG. 2, the positional relationship of the roller 33, the plunger 31 and the cam main body 21 of the high pressure fuel pump 1 of the present embodiment will be described.

As discussed above, the roller 33, which is configured into the cylindrical form, contacts the cam main body 21. While the contact state of the roller 33 relative to the cam main body 21 is maintained, the cam main body 21 is rotated in a counterclockwise direction in the cross-sectional view shown in FIG. 2.

The roller 33 is arranged such that the center P3 of the circle of the roller 33, which is the rotational center of the roller 33, is placed along an axis (hereinafter referred to as a slide axis) L1, along which the plunger 31 slidably reciprocates. The roller 33 is brought into line contact with the cam main body 21. When the roller 33 and the cam main body 21 are viewed in a direction of the axis of the cam main body 21 (i.e., a direction of the axis of the camshaft 20), the roller 33 and the cam main body 21 contact with each other at a point P1 (hereinafter this point will be referred to as a contact point P1). A straight line (hereinafter referred to as a radial contact line) L3 connects between the contact point P1 and the center P3 of the circle of the roller 33. This radial contact line L3 is set to extend through the center (rotational center) P4 of the cam main body 21. The plunger 31 and the cylinder 11 are arranged such that the slide axis L1 is tilted relative to the radial contact line L3 by a predetermined tilt angle α in the counter-rotational direction of the cam main body 21, which is opposite from the rotational direction R of the cam main body 21. In the present embodiment, the predetermined tilt angle α is set to be eight degrees (or slightly less than eight degrees).

With reference to FIG. 2, the slide axis L1 and a tangent line L2 to the circle of the cross section of the roller 33 at the contact point P1 (hereinafter referred to as a tangent line L2 at the contact point P1) intersect with each other at an intersection point (hereinafter also referred to as an imaginary intersection point) P2. Here, since the slide axis L1 is tilted by the predetermined tilt angle α relative to the radial contact line L3 in the counter-rotational direction of the cam main body 21, which is opposite from the rotational direction R of the cam main body 21, the intersection point P2 is displaced from the contact point P1 in the rotational direction R of the cam main body 21. In other words, the roller 33 and the cam main body 21 are arranged such that the contact point P1 is displaced from the imaginary intersection point P2 in the counter-rotational direction of the cam main body 21, which is opposite from the rotational direction R of the cam main body 21. At the contact point P1, the cam lobes 22 and the cam valleys 23 alternately slidably contact the roller 33 when the cam main body 21 is rotated. A load (hereinafter referred to as an urging resultant force F20), which is a resultant force of a load of the slidable arrangement 30 and an urging force of the spring 34, is applied to the contact point P1, at which the roller 33 and the cam main body 21 contact with each other. When the cam main body 21 is rotated against the urging resultant force F20 applied to the contact point P1, friction is generated at the contact point P1 in the rotational direction R of the cam main body 21, and a rotational force is exerted to the roller 33 in a direction of the tangent line L2 at the contact point P1 in proportional to this friction generated at the contact point P1. Due to this rotational force, the roller 33 is rotated about the center P3 of the circle of the roller 33 in the counter-rotational direction of the cam main body 21, which is opposite from the rotational direction R of the cam main body 21.

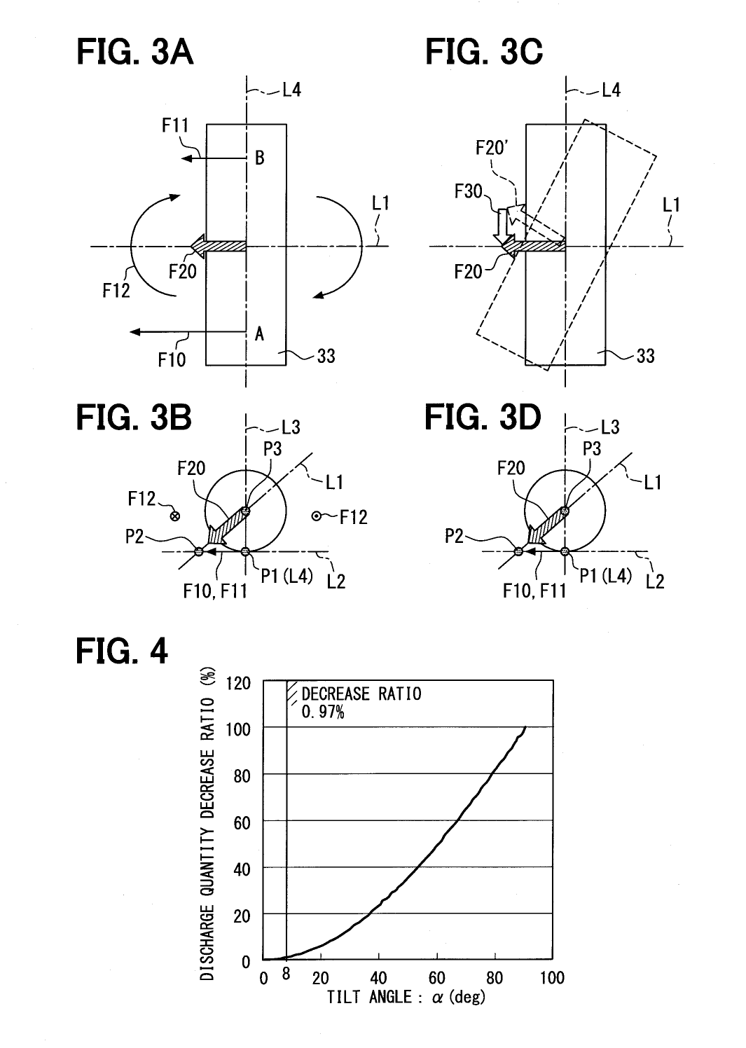

Next, with reference to FIGS. 3A and 3B, there will be described advantages that are achieved by the displacement of the contact point P1, which is located between the roller 33 and the cam main body 21, from the imaginary intersection point P2 in the counter-rotational direction of the cam main body 21, which is opposite from the rotational direction R of the cam main body 21.

FIG. 3A is a top view of the roller 33 viewed from the base end side of the high pressure fuel pump 1 for describing the forces, and FIG. 3B is a cross-sectional view of the roller 33 of FIG. 3A for describing the forces. FIG. 3C is a top view of the roller 33 viewed from the base end side of the high pressure fuel pump 1 for describing a restoring force, and FIG. 3D is a cross-sectional view of the roller 33 of FIG. 3C for describing the restoring force. As indicated in FIG. 3A, the roller 33 receives a rotational force from the cam main body 21 at a contact line L4, at which the roller 33 is brought into line contact with the cam main body 21, and this contact line L4 extends through the contact point P1 shown in FIG. 3B. At this time, due to presence of small tilt of the roller 33 along the contact line L4 and/or a mechanical error, the friction, which is applied to the roller 33, varies along the contact line L4, i.e., varies from one point to another point along the contact line L4.

For example, with reference to FIGS. 3A and 3B, it is now assumed for the descriptive purpose that the roller 33 is divided into an A-point side (see a sign A in

FIG. 3A) and a B-point side (see a sign B in FIG. 3A) along the contact line L4, and a contact pressure between the roller 33 and the cam main body 21 in the B-point side is reduced due to occurrence of wearing while a contact pressure between the roller 33 and the cam main body 21 in the A-point side is increased. In such a case, a force (rotational force) F10, which drives the A-point side of the roller 33 to rotate the A-point side of the roller 33 about the center P3 of the circle of the roller 33, becomes larger than a force (rotational force) F11, which drives the B-point side of the roller 33 to rotate the B-point side of the roller 33 about the center P3 of the circle of the roller 33. In this way, the roller 33 receives a turning force F12, which is a force for turning the roller 33 in a clockwise direction in the view (see FIG. 3A) taken from the base end side and corresponds to a difference between the force F10, which drives the A-point side of the roller 33 to rotate the A-point side of the roller 33 about the center P3 of the circle of the roller 33, and the force F11, which drives the B-point side of the roller 33 to rotate the B-point side of the roller 33 about the center P3 of the circle of the roller 33.

In contrast, the urging resultant force F20 is applied to the roller 33 toward the distal end side in the direction of the slide axis L1 due to the tilting of the plunger 31 by the predetermined tilt angle α. The urging resultant force F20 is always applied in the direction of the slide axis L1 and is divided into a force component in a direction of the radial contact line L3, and a force component in a perpendicular direction that is perpendicular to the radial contact line L3. Here, when the turning force F12 is applied to the roller 33 to turn the roller 33 in the horizontal direction (the clockwise direction in FIG. 3A), the direction of the urging resultant force F20 tends to be changed in the turning direction of the roller 33, as indicated in FIG. 3C. However, since the slide axis L1 of the plunger 31 does not change, the urging resultant force F20 is always applied toward the distal end side of the slide axis L1. Therefore, due to the presence of the urging resultant force F20, which is always applied in the direction of the slide axis L1, there is generated a restoring force F30, which is exerted to restore an imaginary urging resultant force F20′ exerted upon occurrence of attempt to turn the roller 33.

Here, the rotational forces F10, F11, which are generated by the friction generated between the cam main body 21 and the roller 33 at the contact point P1, are exerted in the direction of the tangent line L2 at the contact point P1. Furthermore, as indicated in FIGS. 3C and 3D, the urging resultant force F20, which is generated at the roller 33, is exerted toward the distal end side in the direction of the slide axis L1 of the plunger 31. Therefore, in order to generate the restoring force F30 against the turning force F12, which is exerted to turn the roller 33, it is required to intersect a vector of the rotational forces F10, F11 of the roller 33 with a vector of the urging resultant force F20 exerted toward the distal end side in the direction of the slide axis L1. In a case where the rotational direction of the cam main body 21 is determined, the rotational forces F10, F11 of the roller 33 are exerted at the contact point P1 in the determined rotational direction. Therefore, when the roller 33, the cylinder 11 and the cam main body 21 are arranged such that the contact point P1 between the roller 33 and the cam main body 21 is displaced from the imaginary intersection point P2, at which the slide axis L1 and the tangent line L2 at the contact point P1 intersect with each other, in the counter-rotational direction of the cam main body 21, which is opposite from the rotational direction R of the cam main body 21, it is possible to intersect the vector of the rotational force at the contact point P1 of the roller 33 with the vector of the urging resultant force F20 generated toward the distal end side in the direction of the slide axis L1. In this way, the restoring force F30 is exerted in an opposite direction (also referred to as a counter-turning direction that is a counterclockwise direction in FIG. 3C), which is opposite from the direction (turning direction) of the turning force F12. Thereby, the turning of the roller 33 can be limited.

Next, the tilt angle of the slide axis L1 will be described with reference to FIG. 4. FIG. 4 is a diagram indicating a relationship between the predetermined tilt angle α and a change ratio (decrease ratio) of the discharge quantity of the fuel from the high pressure fuel pump 1 in the case where the slide axis L1 is tilted relative to the radial contact line L3 by the predetermined tilt angle α. Here, the tilt angle of zero (0) degrees indicates a state where the cam main body 21, the roller 33 and the plunger 31 are arranged such that the slide axis L1 of the plunger 31 overlaps with, i.e., coincides with the radial contact line L3.

According to FIG. 4, it is understood that when the predetermined tilt angle α is increased, the discharge quantity of the fuel, which is discharged from the high pressure fuel pump 1, is reduced. This is due to the fact that when the plunger is tilted, a slide distance (reciprocation distance) of the plunger is reduced, and a pushed amount (pushed distance) of the plunger 31, which is pushed by the cam main body 21, is reduced. Here, when it is assumed that the variations in the discharge quantity of fuel follow a principle of a standard deviation σ, an error of ±2-3σ is present in the discharge quantity of fuel at the tilt angle of zero (0) degrees. When the discharge quantity of fuel of the high pressure fuel pump 1 is controlled, it is desirable that a control operation, which reflects this error, is performed. Thus, when a decrease in the discharge quantity of fuel is within an error range of ±2-3σ, the control operation for controlling the discharge quantity of fuel can be performed without requiring a substantial change (modification) in the control operation.

With reference to FIG. 4, at the tilt angle of eight degrees, a decrease ratio of the discharge quantity of fuel is 0.97. This decrease ratio of 0.97 falls in an error range between the error of about 0.37, which is the standard deviation of ±3σ, and the error of about 4.6, which is the standard deviation of ±2σ. Therefore, it is desirable that the tilt angle, which does not require a change in the control operation for controlling the discharge quantity, is less than eight degrees.

Next, advantages of the present embodiment will be described.

In the present embodiment, the contact point P1, which is the contact point between the roller 33 and the cam main body 21 seen in the direction of the axis of the camshaft 20 (the direction of the axis of the cam main body 21), is displaced from the intersection point P2, at which the slide axis L1 of the plunger 31 and the tangent line L2 at the contact point P1 intersect with each other, in the counter-rotational direction of the cam main body 21, which is opposite from the rotational direction R of the cam main body 21. With this arrangement, the restoring force F30, which is exerted to the roller 33 due to the urging resultant force F20 applied to the roller 33 toward the distal end side in the direction of the slide axis L1, is exerted in the direction for limiting the turning of the roller 33. Therefore, the turning of the roller 33 can be limited. Thereby, it is possible to limit the seizing of the roller 33, and thereby it is possible to improve the reliability of the high pressure fuel pump 1 with respect to the function of supplying the fuel to the internal combustion engine.

Furthermore, it is desirable that the center P3 of the circle of the roller 33 is placed along the slide axis L1 of the plunger 31. In this way, the contact point between the roller 33 and the cam main body 21 appears in an apex of the cam lobe 22. Thus, a top dead center of the plunger 31, at which the fuel is compressed in the maximum degree by the plunger 31, and a bottom dead center of the plunger 31, at which the plunger 31 is moved to the most distal end side along the cylinder 11, respectively appear at the top dead center and the bottom dead center of the plunger 31, which appear in the case where the plunger 31 is not tilted. That is, the top dead center and the bottom dead center of the cam profile, which indicates the locations of the plunger 31 at the time of reciprocating the plunger 31 upon rotation of the cam main body 21, respectively coincide with the top dead center and the bottom dead center of the cam profile, which is formed in the case where the plunger 31 is not tilted. In this way, without causing a substantial change in the discharge quantity of fuel at the high pressure fuel pump 1 computed with reference to the cam profile, and a substantial change in a control operation for controlling a fuel injection quantity, the control operation(s) can be easily performed.

In addition, it is desirable that the cylinder 11 is tilted such that the slide axis L1 of the plunger 31 is tilted relative to the radial contact line L3 in the counter-rotational direction of the cam main body 21. With this arrangement, the distance from the contact point P1 to the imaginary intersection point P2 can be adjusted only by the tilting of the cylinder 11. Thus, the roller 33, the plunger 31, and the cam main body 21 can be arranged such that when the roller 33 and the cam main body 21 are viewed in the direction of the axis of the camshaft 20, the contact point P1 (i.e., the point, at which the roller 33 and the cam main body 21 contact with each other) is displaced from the intersection point P2 (i.e., the point, at which the slide axis L1 of the plunger 31 and the tangent line L2 to the circle of the cross section of the roller 33 at the contact point P1 intersect with each other) in the counter-rotational direction of the cam main body 21, which is opposite from the rotational direction R of the cam main body 21, so that the restoring force is appropriately applied to the roller 33. Accordingly, it is possible to limit the seizing of the roller 33, and thereby it is also possible to improve the reliability of the high pressure fuel pump 1 with respect to the function of supplying the fuel to the internal combustion engine.

It is desirable that the tilt angle of the slide axis L1 is larger than zero degrees and is smaller than eight degrees. In this way, the turning of the roller 33 can be limited while limiting the amount of decrease in the discharge quantity caused by the tilting of the slide axis L1. Therefore, it is possible to limit the seizing of the roller 33, and thereby it is also possible to improve the reliability of the high pressure fuel pump 1 with respect to the function of supplying the fuel to the internal combustion engine.

### Second Embodiment

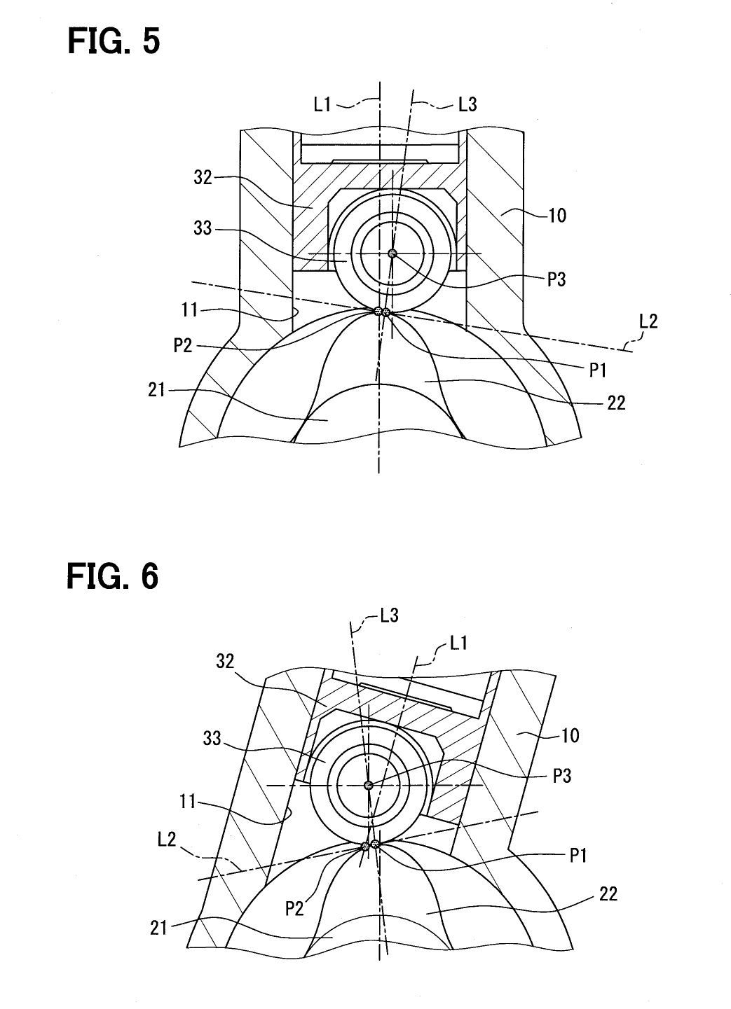

As shown in FIG. 5, according to a second embodiment of the present disclosure, the cam main body 21 and the slidable arrangement 30 are arranged such that the slide axis L1 of the plunger 31 extends through the center (rotational center) P4 of the cam main body 21. Specifically, the cylinder 11 is perpendicular to the cam main body 21 and is not tilted relative to the cam main body 21. The roller 33 is arranged such that the center P3 of the circle of the roller 33 is displaced from the slide axis L1 in the counter-rotational direction of the cam main body 21, which is opposite from the rotational direction R of the cam main body 21.

When the center P3 of the circle of the roller 33 is displaced from the slide axis L1 in the above-described manner, the radial contact line L3, which connects between the center P3 of the circle of the roller 33 and the contact point P1, is displaced from the slide axis L1 in the counter-rotational direction of the cam main body 21, which is opposite from the rotational direction R of the cam main body 21. Therefore, even when the roller 33, the cam main body 21, and the tappet body 32 are arranged in the above described manner, the contact point P1 is displaced from the imaginary intersection point P2 in the counter-rotational direction of the cam main body 21, which is opposite from the rotational direction R of the cam main body 21.

Thus, even in the second embodiment, the restoring force F30, which is applied to the roller 33 due to the urging resultant force F20 applied toward the distal end side in the direction of the slide axis L1, is exerted in the direction (the counter-turning direction) for limiting the turning of the roller 33. Thus, the turning of the roller 33 can be limited. Therefore, it is possible to limit the seizing of the roller 33, and thereby it is possible to improve the reliability of the high pressure fuel pump 1 with respect to the function of pressurizing the fuel and supplying the pressurized fuel to the outside of the high pressure fuel pump 1.

In the present embodiment, the contact point P1 is displaced from the imaginary intersection point P2 in the counter-rotational direction, which is opposite from the rotational direction R of the cam main body 21, by displacing the center P3 of the circle of the roller 33 from the slide axis L1 instead of tilting the cylinder 11. In this way, for example, by changing the configuration of the holding portion 321 of the tappet body 32, a holding position of the roller 33 can be changed such that the contact point P1 is displaced from the imaginary intersection point P2 in the counter-rotational direction of the cam main body 21, which is opposite from the rotational direction R of the cam main body 21. Therefore, with the simple structure, it is possible to limit the turning of the roller 33, and thereby it is possible to improve the reliability of the high pressure fuel pump 1 with respect to the function of supplying the fuel to the internal combustion engine.

### Third Embodiment

As shown in FIG. 6, according to a third embodiment of the present disclosure, the cylinder 11 is tilted relative to the cam main body 21 such that the slide axis L1 of the plunger 31 does not extend through the center (rotational center) P4 of the cam main body 21. Furthermore, in the inside of the tappet body 32, the roller 33 is arranged such that the roller 33 is placed on the side of the cam main body 21 in the rotational direction R of the cam main body 21. In other words, the center P3 of the circle of the roller 33 is displaced from the slide axis L1 of the plunger 31 in the rotational direction R of the cam main body 21, and the plunger 31 and the cylinder 11 are tilted such that the slide axis L1 of the plunger 31 is tilted relative to the radial contact line L3, which connects between the center P3 of the circle of the roller 33 and the contact point P1, in the counter-rotational direction of the cam main body 21. Thus, the radial contact line L3 and the slide axis L1 are not located along a common straight line. That is, the radial contact line L3 does not coincide with the slide axis L1. Therefore, even when the roller 33, the cam main body 21, and the tappet body 32 are arranged in the above described manner, the contact point P1 is displaced from the imaginary intersection point P2, at which the tangent line L2 (i.e., the line L2 that is perpendicular to the radial contact line L3) and the slide axis L1 intersect with each other, in the counter-rotational direction of the cam main body 21, which is opposite from the rotational direction R of the cam main body 21. Thus, when the cylinder 11, the roller 33, the cam main body 21, and the tappet body 32 are arranged in the above-described manner, it is possible to limit the turning of the roller 33, and thereby it is possible to improve the reliability of the high pressure fuel pump 1 with respect to the function of supplying the fuel to the internal combustion engine.

### Fourth Embodiment

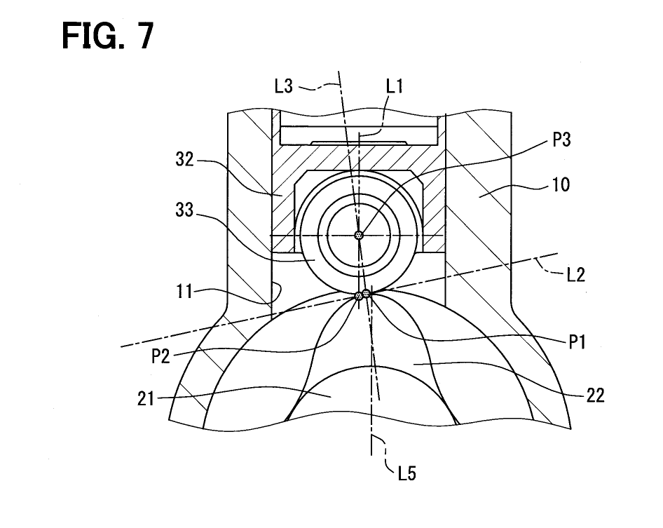

As shown in FIG. 7, according to a fourth embodiment of the present disclosure, the cylinder 11 and the cam main body 21 are arranged such that the slide axis L1 of the plunger 31 does not extend through the center (rotational center) P4 of the cam main body 21. The slide axis L1 is offset from a straight line L5, which is parallel to the slide axis L1 and extends through the center (rotational center) P4 of the cam main body 21, in the rotational direction R of the cam main body 21. That is, although the cylinder 11 extends in the direction perpendicular to the cam main body 21, the slide axis L1 of the plunger 31 (the slide axis of the slidable arrangement 30), which is slid in the cylinder 11, does not extend through the center (rotational center) P4 of the cam main body 21. In addition, the roller 33 is arranged such that the rotational center P3 of the roller 33 is located along the slide axis L1. Therefore, similar to the third embodiment, even in the present embodiment, the radial contact line L3 and the slide axis L1 are not located along a common straight line. That is, the radial contact line L3 does not coincide with the slide axis L1. Furthermore, in the present embodiment, the cylinder 11, the roller 33, the cam main body 21, and the tappet body 32 are arranged such that the radial contact line L3 is tilted related to the slide axis L1 in the rotational direction R of the cam main body 21.

Therefore, even when the cylinder 11, the roller 33, the cam main body 21, and the tappet body 32 are arranged in the above described manner, the contact point P1 is displaced from the imaginary intersection point P2, at which the tangent line L2 (i.e., the line L2 that is perpendicular to the radial contact line L3) and the slide axis L1 intersect with each other, in the counter-rotational direction of the cam main body 21, which is opposite from the rotational direction R of the cam main body 21. Thus, when the roller 33, the cam main body 21, and the tappet body 32 are arranged in the above-described manner, it is possible to limit the turning of the roller 33, and thereby it is possible to improve the reliability of the high pressure fuel pump 1 with respect to the function of supplying the fuel to the internal combustion engine.

Furthermore, when the slide axis L1 is offset from the cam main body 21, the contact point P1, at which the roller 33 is rotated by the cam main body 21, appears on the side of the most distal end part of the roller 33 in the counter-rotational direction of the cam main body 21, which is opposite from the rotational direction R of the cam main body 21. In this way, the contact load between the cam main body 21 and the roller 33 is increased, and thereby the rotational force, which rotates the roller 33, is increased. Thereby, the rotational force can be effectively conducted from the camshaft 20 to the roller 33.

The present disclosure has been described with respect to the various embodiments of the present disclosure. However, the present disclosure is not limited to the above embodiments, and the above embodiments may be modified in various ways within a principle of the present disclosure.

What is claimed is:

1. A high pressure fuel pump comprising:
a housing body that includes a cylinder, which is configured into a cylindrical form;
a cam main body that includes a plurality of cam lobes, which are radially outwardly projected, wherein the cam main body is connected to a camshaft, which is rotated synchronously with a crankshaft of an internal combustion engine;
a plunger that slidably reciprocates along a slide axis in an inside of the cylinder of the housing body;
a tappet body that is placed on a side of the plunger, at which the cam main body is placed, wherein the tappet body slidably reciprocates integrally with the plunger; and
a roller that is held by the tappet body and is in contact with the cam main body, wherein the roller is rotated by rotation of the camshaft and has a cross section that is configured into a circle, wherein:
fuel, which is drawn into a pressurizing chamber formed in the cylinder, is compressed and is discharged from the high pressure fuel pump when the plunger is reciprocated through the tappet body that is in turn reciprocated by the plurality of cam lobes, which are rotated by the rotation of the camshaft;
the roller and the cam main body are arranged such that when the roller and the cam main body are viewed in a direction of an axis of the camshaft, a contact point, at which the roller and the cam main body contact with each other, is displaced from an intersection point, at which the slide axis of the plunger and a tangent line to the circle of the cross section of the roller at the contact point intersect with each other, in a counter-rotational direction of the cam main body, which is opposite from a rotational direction of the cam main body.

2. The high pressure fuel pump according to claim 1, wherein a center of the circle of the cross section of the roller is placed along the slide axis of the plunger.

3. The high pressure fuel pump according to claim 1, wherein the plunger and the cylinder are tilted such that the slide axis of the plunger is tilted relative to a straight line, which connects between the center of the circle of the cross section of the roller and the contact point, in the counter-rotational direction of the cam main body.

4. The high pressure fuel pump according to claim 1, wherein:
the plunger and the cam main body are arranged such that the slide axis of the plunger extends through a rotational center of the cam main body; and
the center of the circle of the cross section of the roller is displaced from the slide axis of the plunger in the counter-rotational direction of the cam main body.

5. The high pressure fuel pump according to claim 1, wherein:
the center of the circle of the cross section of the roller is displaced from the slide axis of the plunger in the rotational direction of the cam main body; and
the plunger and the cylinder are tilted such that the slide axis of the plunger is tilted relative to a straight line, which connects between the center of the circle of the cross section of the roller and the contact point, in the counter-rotational direction of the cam main body.

6. The high pressure fuel pump according to claim 3, wherein a tilt angle of the slide axis of the plunger relative the straight line, which connects between the center of the circle of the cross section of the roller and the contact point, is larger than zero degrees and is smaller than eight degrees.

7. The high pressure fuel pump according to claim 1, wherein:
the plunger and the cylinder are arranged such that the slide axis of the plunger is offset from a straight line, which is parallel to the slide axis of the plunger and extends through a rotational center of the camshaft, in the rotational direction of the cam main body; and
the roller is arranged such that the center of the circle of the cross section of the roller is placed along the slide axis of the plunger.
